(19) United States
(12) Patent Application Publication
(10) Pub. No.: US 2025/0270955 A1
(43) Pub. Date: Aug. 28, 2025

(54) Methods for Capacity Enhancement for a Gas Turbine Using Air Injection

(71) Applicant: Electric Power Research Institute, Inc., Palo Alto, CA (US)

(72) Inventor: Dale Stewart Grace, Menlo Park, CA (US)

(21) Appl. No.: 18/706,661

(22) PCT Filed: Nov. 1, 2022
(86) PCT No.: PCT/US2022/048612

§ 371 Date: May 1, 2024

Related U.S. Application Data
(60) Provisional application No. 63/275,318, filed on Nov. 3, 2021.

(51) Int. Cl. F02C 6/18; F02C 3/00; F02C 7/22; F02C 9/18

(52) U.S. Cl. CPC F02C 6/18; F02C 3/00; F02C 7/22; F02C 9/18

(57) ABSTRACT

In general, the present invention is directed to methods for enhancing or improving the performance of a gas turbine. Generally, the present invention provides a method for adding additional air directly to a specific area within the compressor section of the gas turbine. In some embodiments, a separate or auxiliary air compressor can be used to provide a compressed air stream that is fed to certain points within the compressor section of the gas turbine in addition to the air normally being fed to the compressor inlet. By adding such additional air the total mass flow rate of air ultimately going to the combustion section of the gas turbine is increased, thereby providing for a corresponding increase in power output of the turbine section of the gas turbine.

### BACKGROUND OF THE INVENTION

### Field of the Invention

The invention, including its various embodiments, relates to methods for capacity enhancement or improving performance of a gas turbine. In particular, the invention, including its various embodiments, relates to methods for injecting air into one or more locations within the gas turbine compressor, utilizing pre-existing ports designed for bleeding or extracting air from the compressor, to increase mass air flow to the combustion section and turbine sections of the gas turbine, thereby increasing the power output of the gas turbine.

### Description of Related Art

Gas turbines are used in various industries, including, for example, the power generation industry. When used for power generation, gas turbines are used to drive a generator to produce electricity. However, gas turbine performance can be affected by various factors, including, for example, higher inlet air temperature and/or installation of the gas turbine at higher elevation, which reduces air density. An increase in inlet air temperature results in a reduction in air flow through the gas turbine and a corresponding reduction in power output. Similarly, installation of a gas turbine at higher elevations also results in a lower mass flow of air into the gas turbine. Accordingly, these factors result in the given gas turbine operating below its rated capacity.

Increasing the full load output of a gas turbine compared with its output that would otherwise occur at certain ambient temperature and pressure conditions, often with the intent of restoring operation to its nominal rating, is referred to as “capacity enhancement” or “power augmentation.” Such techniques can also improve gas turbine efficiency. Various capacity enhancement techniques or processes have been used. For example, inlet air cooling using chillers, evaporative coolers, or foggers has been used to reduce inlet air temperature. However, such may not fully restore the gas turbine to full net capacity, nor do such address elevational issues. Fogging overspray beyond saturation conditions at the compressor inlet can increase capacity but at the risk of droplet impaction on compressor blading. Steam injection at the compressor outlet, using steam generated from heat recovered from the gas turbine exhaust (either combined cycle plants or Cheng cycle plants), can also be used for increasing gas turbine capacity but with potential durability consequences. Injection of dry air or humid air downstream of the gas turbine's compressor, prior to the combustor, has also been used. For example, a reciprocating engine or electric motor can be used to drive a centrifugal compressor to inject the dry air downstream of the gas turbine compressor. However, all of these techniques involve additional costs and limitations on performance improvements.

Accordingly, there is a need for improved techniques and methods for improving gas turbine performance. Specifically, there is a need for such improved techniques and methods that minimize the use of additional equipment, capital expenditures, and detrimental effects on the gas turbine equipment.

### BRIEF SUMMARY OF THE INVENTION

In general, the present invention is directed to methods for enhancing or improving the performance of a gas turbine. Generally, the present invention provides a method for adding additional air directly to a specific area within the compressor section of the gas turbine. In some embodiments, a separate or auxiliary air compressor can be used to provide a compressed air stream that is fed to certain points within the compressor section of the gas turbine in addition to the air normally being fed to the compressor inlet. By adding such additional air the total mass flow rate of air ultimately going to the combustion section of the gas turbine is increased, thereby providing for a corresponding increase in power output of the turbine section of the gas turbine.

In one embodiment, the present invention provides a method for increasing the capacity of a gas turbine, comprising providing a gas turbine comprising a compressor section having a first compressor, a combustion chamber, and a turbine; compressing air using a second compressor to produce compressed air from the second compressor; feeding the compressed air from the second compressor into the first compressor to produce compressed air from the first compressor; passing the compressed air from the first compressor to the combustion chamber; feeding a fuel to the combustion chamber; combusting the compressed air and the fuel in the combustion chamber to produce a gas stream; and passing the gas stream through a turbine to rotate the turbine. In some embodiments, feeding the compressed air from the second compressor into the first compressor comprises feeding the compressed air from the second compressor into the first compressor through a pre-existing bleed port or extraction port.

In another embodiments, the present invention provides a method for increasing the capacity of a gas turbine, comprising providing a gas turbine comprising a compressor section having a first compressor, a combustion chamber, and a turbine; compressing air using a second compressor to produce compressed air from the second compressor; feeding the compressed air from the second compressor into the first compressor to produce compressed air from the first compressor; passing the compressed air from the first compressor to the combustion chamber; feeding a fuel to the combustion chamber; combusting the compressed air and the fuel in the combustion chamber to produce a gas stream; passing the gas stream through a turbine to rotate the turbine and producing an exhaust gas stream from the turbine; and passing the exhaust gas stream to a heat recovery steam generator. In some embodiments, feeding the compressed air from the second compressor into the first compressor comprises feeding the compressed air from the second compressor into the first compressor through a pre-existing bleed port or extraction port.

In addition to providing an increase in power output of the turbine section of the gas turbine, the present invention provides numerous other benefits and advantages. For example, compared with steam addition, in some embodiments, only dry air is used, so no water is lost to the stack and less water treatment is required. Further, there are no durability impacts that otherwise result from steam addition. Compared with inlet cooling via chillers, the present invention provides possibly higher capacity improvement with potentially less capital investment. Compared with inlet cooling via fogging or evaporative coolers, the present invention provides air addition that is not limited by approach to ambient wet bulb temperature/ambient humidity. Air injection can be an effective adjunct to inlet cooling since it can potentially increase power to fully rated conditions. Compared with fogging overspray, there is no risk of droplet impingement and wear on compressor airfoils and no additional water consumption. Compared with simple motor driven air injection to the main compressor outlet, compressor hardware options are available to provide the required mass flow at lower pressure ratio at lower capital cost and possibly without the need for intercooling and associated loss of energy from the process.

### BRIEF DESCRIPTION OF THE SEVERAL VIEWS OF THE DRAWINGS

FIG. 1 is a process flow diagram of a gas turbine process utilizing additional air according to one embodiment of the present invention;

FIG. 2A illustrates a cut-away side view of a gas turbine compressor according to one embodiment of the present invention;

FIG. 2B illustrates a sectional view of a gas turbine compressor according to one embodiment of the present invention; and

FIG. 3 is a process flow diagram of a gas turbine combined cycle process utilizing additional air according to one embodiment of the present invention.

### DETAILED DESCRIPTION OF THE INVENTION

The present invention is more fully described below with reference to the accompanying drawings. While the present invention will be described in conjunction with various embodiments, such should be viewed as examples and should not be viewed as limiting or as setting forth the only embodiments of the invention. Rather, the present invention includes various embodiments or forms, various related aspects or features, and various uses, as well as alternatives, modifications, and equivalents to the foregoing, all of which are included within the spirit and scope of the invention and the claims, whether or not expressly described herein. Further, the use of the terms “invention,” “present invention,” “embodiment,” and similar terms throughout this description are used broadly and are not intended to mean that the invention requires, or is limited to, any particular embodiment or aspect being described or that such description is the only manner in which the invention may be made or used.

In general, the present invention is directed to methods for enhancing or improving the performance of a gas turbine. Generally, a gas turbine has three sequential sections that operate to convert chemical energy into mechanical energy. The first section is a compressor section in which a gas, typically air, is compressed. The compressed air is then passed to a combustion section in which fuel is mixed with the compressed air and combusted to substantially increase the temperature of the air. The resulting gas produced from the combustion section then passes to a turbine section in which the high temperature, high pressure gas stream is used to turn the turbine, thereby converting the chemical energy into mechanical energy, a portion of which is used to drive the compressor. In power generation, the turbine is then used to turn a generator shaft to produce electricity.

In some instances, the gas turbine operates at below its nominal rated capacity due to various factors. For example, an increase in inlet gas or air temperature results in a reduction in mass air flow through the gas turbine and a corresponding reduction in power output. Similarly, installation of a gas turbine at higher elevations also results in a lower mass flow of air into the gas turbine. Both of these factors can be addressed by increasing the mass air flow through the gas turbine. The present invention provides various methods for increasing the mass air flow through the gas turbine to improve its output capacity.

Generally, in one embodiment, the present invention provides a method for adding additional air directly to a specific area within the compressor section of the gas turbine. In this embodiment, a separate or auxiliary air compressor can be used to provide a compressed air stream that is fed to certain points within the compressor section of the gas turbine. It should be appreciated that this additional air is in addition to the air normally being fed to the compressor inlet. By adding such additional air the total mass flow rate of air ultimately going to the combustion section of the gas turbine is increased, thereby providing for a corresponding increase in power output of the turbine section of the gas turbine.

It should be appreciated that there are various compressor designs that can be used in a gas turbine. However, generally, there are various stages within the compressor having various designs of rotating blades. These stages are sequential such that there are separate rows of blades. For example, in an axial compressor, each stage may have a row of rotating blades, each located axially along the compressor shaft and positioned along the compressor shaft. The rotating blades rotate axially about the compressor shaft to compress the air as it flows through the compressor and the various stages. In some embodiments, the specific point(s) at which the air stream is injected into the compressor section include one or more locations along the compressor or at different stages. In some embodiments, the air stream may be injected into various locations along the compressor using existing ports designed for bleeding or releasing air pressure within the compressor or ports designed to extract air from the compressor for cooling turbine components or both. In this manner, as described above, the amount of air being compressed and fed to the combustion section of the gas turbine is increased, thereby enhancing the capacity of the gas turbine power output.

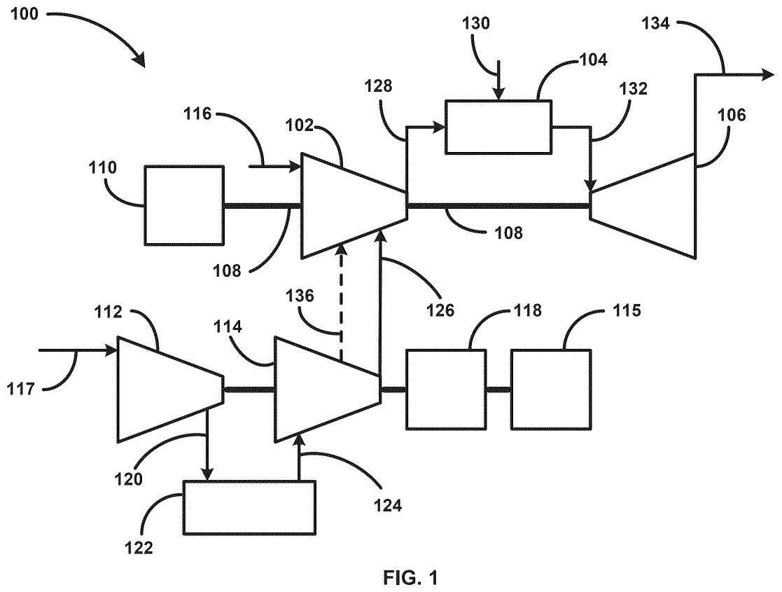

FIG. 1 is a process flow diagram of a gas turbine process utilizing additional air according to one embodiment of the present invention. The gas turbine process 100 utilizes a gas turbine having a compressor section including a compressor 102 such as an axial compressor, a combustion section 104, and a turbine section including a turbine 106. As an example, the compressor 102 is shown as sharing a rotating shaft 108 with the turbine 106. In this process 100, the gas turbine is used to generate power as illustrated by the compressor 102 and the turbine 106 sharing the same rotating shaft 108 with a generator 110. In addition, the gas turbine process 100 includes an auxiliary air compressor having multiple sections 112, 114 and driven by a corresponding motor 115 and gear box 118. (It should be appreciated that the auxiliary air compressor in FIG. 1 is the combination of the two of these multiple compressor sections 112, 114; however, the auxiliary air compressor may have additional compressor sections.) The auxiliary compressor sections 112, 114 may be of various designs, including, for example, axial, radial, or centrifugal, and in some embodiments designed with multiple stages of intercooling for improved efficiency. The auxiliary compressor motor 115 may be, for example, an electric motor, with or without variable speed drive. It should be appreciated that in some embodiments, the auxiliary air compressor having multiple stages or sections may be an integrally geared centrifugal compressor.

In operation, ambient air 116 is pulled into the compressor 102 and compressed. In addition, the first section 112 of the auxiliary air compressor driven by the motor 115 also compresses ambient air 117 and passes the compressed air 120 to an intercooler 122 that cools the compressed air before passing the now cooled compressed air 124 to the second section 114 of the auxiliary air compressor, which further compresses the air to generate an auxiliary compressed air stream 126 that is fed to the compressor 102.

The compressor 102 takes the ambient air 116 and the auxiliary compressed air stream 126 from the second section 114 of the auxiliary compressor and further compresses the combined air stream to produce a compressed air stream 128 that is fed to the combustion section 104. Accordingly, it should be appreciated that the compressed air stream 128 exiting the compressor 102 is a combined compressed air stream having compressed air from the auxiliary compressor and the main compressor 102. Fuel 130 is also fed to the combustion section 104. The fuel 130 and the compressed air 128 are combusted to generate a high temperature, high pressure gas stream 132 that is fed to the turbine 106. The turbine 106 is caused to rotate, which concurrently rotates the shaft 108 associated with the generator 110, which in turn produces electricity. An exhaust gas stream 134 is discharged from the turbine 106.

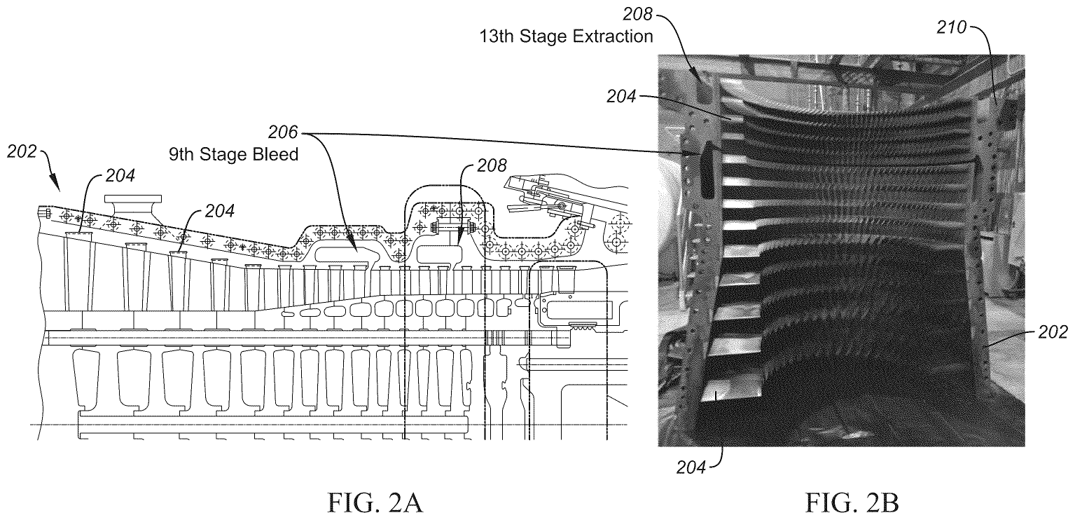

It should be appreciated that the auxiliary compressed air stream 126 from the second section 114 of the auxiliary compressor may be fed or injected at various locations within the gas turbine compressor 102 or along the compressor 102, as opposed to simply added to the air at either the inlet of the compressor 102 or at the outlet of the compressor 102. In addition, it should be appreciated that a second auxiliary compressed air stream 136 from the second section 114 of the auxiliary air compressor may optionally be fed or injected to the gas turbine compressor 102 (as represented by the dashed line for the second auxiliary compressed air stream 136 in FIG. 1). Similarly, this second auxiliary compressed air stream 136 from the second section 114 of the auxiliary air compressor may be fed or injected at various locations within the gas turbine compressor 102 or along the compressor 102. The injection of these auxiliary compressed air streams 126, 136 is described in more detail in connection with FIG. 2 below. Generally, however, it should be appreciated that one or more auxiliary compressed air streams from one or more sections of the auxiliary air compressor can be injected at various locations along the compressor 102. Furthermore, multiple intercoolers may be used between sections, and multiple air streams may be obtained after multiple stages or sections and before or after multiple intercoolers.

It should be appreciated that injection of the auxiliary compressed air into the compressor is for the purpose of increasing air mass flow through the compressor and to the combustion section. The net injection depends on the amount of air being fed from the second compressor minus the flow demand for extraction and cooling of turbine components. By adding such additional air the total mass flow rate of air ultimately to the combustion section of the gas turbine is increased, thereby providing for a corresponding increase in power output of the turbine section of the gas turbine. A portion of the increased power output is required to drive the motor of the auxiliary compressor.

In this regard, it should be appreciated that sections 112, 114 of the auxiliary compressor have a design that provides a pressure ratio sufficient to add air at a convenient intermediate location in the gas turbine compressor 102 as described further below. In some embodiments, the auxiliary air compressor pressure ratio is less than the overall pressure ratio of the gas turbine, as the later stages of the gas turbine compressor 102 will complete the compression of this compressed air stream 118 from the auxiliary compressor 112 to the desired operating conditions.

During operation, the amount and flow rate of the compressed air 118 from the auxiliary compressor 112 is limited to maintain sufficient surge margin in the main compressor 102. In some embodiments, sensors and instrumentation can be used to indicate stall conditions, which may predict the onset of surge, which may then be prevented through use of a control system. Accordingly, in some embodiments, the amount of auxiliary air 118 added to the compressor 102 is basically that amount sufficient to maintain the compressor 102 within its allowable operating envelope without surge or excessive stall. In some embodiments, the first section 112 of the auxiliary compressor has inlet guide vanes to control flow. It should be appreciated that air addition is most beneficial once inlet guide vanes in the main compressor 102 are fully open to increase power output beyond full load conditions for a particular inlet air temperature and pressure.

FIG. 2A illustrates a cut-away side view of a gas turbine compressor according to one embodiment of the present invention. As shown in FIG. 2A, the compressor 202 is an example of an axial compressor that is used for compressing air and feeding the compressed air to the combustion section of a gas turbine as described in connection with FIG. 1. The compressor 202 has multiple stages or rows of blades 204. It should be appreciated that a portion of these blades may be stationary, and a portion of these blades may rotate. As described above, a compressor may have various ports available for the injection of the auxiliary compressed air that are used for bleeding off air during startup/shutdown and/or extraction of air for turbine airfoil cooling. A bleed/extraction port 206 is shown, which is located at the 9^{th} stage in this example. An extraction port 208 is also shown, which is located at the 13^{th} stage in this example. It should be appreciated that compressors generally are designed with one or more such bleed/extraction ports, which may be used for the injection of the auxiliary compressed air along the axis of the compressor. Accordingly, these ports may be located at other locations along the compressor 202 or that additional ports may be present at other locations along the compressor 202 depending on the initial gas turbine design.

FIG. 2B illustrates a sectional view of a gas turbine compressor according to one embodiment of the present invention. Shown are the various stages or rows of stationary airfoils 204 in the compressor 202. FIG. 2B also illustrates the physical appearance of the ports shown in FIG. 2A, specifically, the bleed/extraction port 206 and the extraction port 208, which are located in the outside shell 210 of the compressor 202.

In operation, as described above in connection with FIG. 1, air 116 is pulled into the compressor 102 at one end and passes through the compressor 102. The air 116 would pass through the various stages or rows of blades and vanes in the compressor 102, such as the rows of vanes 204 shown in FIGS. 2A and 2B, which in association with rotating blades (not shown) act to compress the air 116 to the desired pressure. The air is then pushed by the compressor 102 into the combustion section 104 of the gas turbine 106 where it is mixed with fuel and combusted to generate the high temperature, high pressure gas stream that is fed to the turbine section of the gas turbine 106.

With reference to FIG. 1, the compressed air 118 from the auxiliary compressors 112, 114 is fed to one or more locations within the compressor 102 or along its axis. In some embodiments, the compressed air 118 from the sections 112, 114 of the auxiliary compressor is fed to one location between the first stage of blades and the last stage of blades, including, for example, at a mid-point between the first stage of blades and the last stage of blades. In some embodiments, the compressed air 118 from the auxiliary compressor 112 is fed to more than one location within the compressor 102, with each location between the first stage of blades and the last stage of blades. In some embodiments, one of the more than one locations is near a mid-point between the first stage of blades and the last stage of blades. It should be appreciated that, in some embodiments, the compressor 102 may be designed to specifically position the bleed ports at those locations where injection of compressed air 118 from the auxiliary compressor 112 is to be made.

It should also be appreciated that in some embodiments, the injection of the auxiliary compressed air stream 126, 136 from the sections 112, 114 or the auxiliary compressor may be via pre-existing passages or ports normally designed or used for bleeding air from within the gas turbine compressor 102, such as bleed ports or extraction ports used during start-up of the gas turbine compressor 102 or to extract air for purposes of cooling the turbine 106, respectively. It should be appreciated that existing ports on the compressor are being used to inject auxiliary air into the compressor for purposes of increasing air mass flow through the compressor and to the combustion section, rather than for discharge of air from the compressor. The net injection depends on the amount of air being fed from the auxiliary compressor minus the flow demand for extraction and cooling of turbine components.

With reference to FIGS. 2A and 2B, the injection locations for the auxiliary compressed air, may be an existing or pre-existing port, such as a bleed port or an extraction port. For example, the auxiliary compressed air may be feed to the 9^{th} stage of the compressor 202 by feeding the auxiliary compressed air through the bleed port 206 located at the 9^{th} stage. The auxiliary compressed air may alternatively be feed to the 13^{th} stage of the compressor 202 by feeding the auxiliary compressed air through the extraction port 208 located at the 13^{th} stage. It should be appreciated that the auxiliary compressed air may be fed to the compressor through both ports concurrently. It should also be appreciated that in some embodiments, the auxiliary compressed air is fed to the compressor through ports that are pre-existing in the compressor. In such embodiments, the present invention can be implemented in any existing compressor having at least one such port without any need to construct or new port in the compressor.

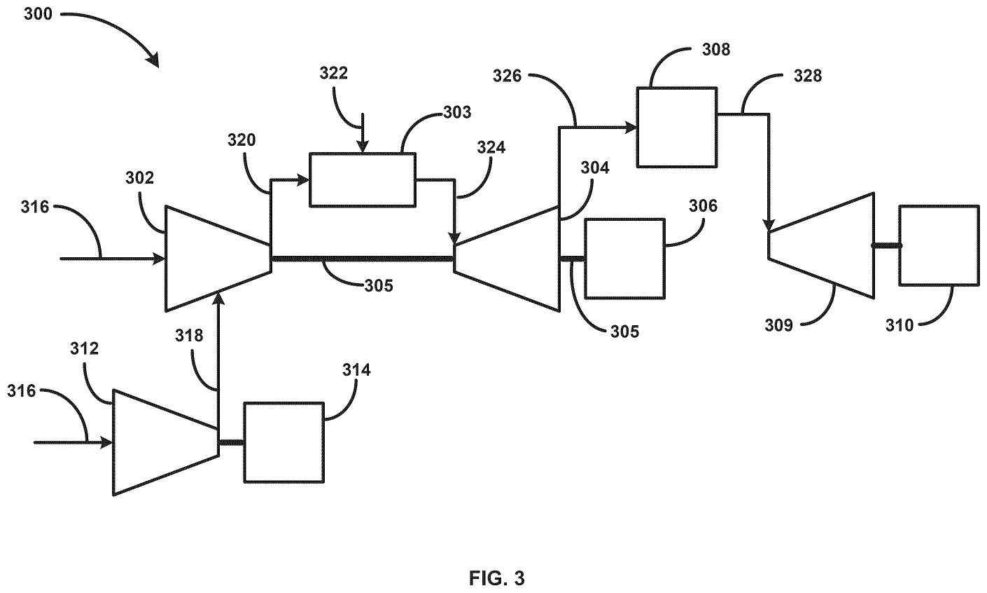

FIG. 3 is a process flow diagram of a gas turbine combined cycle process utilizing additional air according to one embodiment of the present invention. The process 300 shown in FIG. 3 is similar to that shown in FIG. 1 with the exception that this process 300 is a combined cycle process.

Similar to FIG. 1, the gas turbine combined cycle process 300 utilizes a gas turbine having a compressor section including a compressor 302, such as an axial compressor, a combustion section 303, and a turbine section including a turbine 304. As an example, the compressor 302 is shown as sharing a rotating shaft 305 with the turbine 304. In this process 300, the gas turbine is used to generate power as illustrated by the turbine 304 sharing the same rotating shaft 305 with a generator 306. The gas turbine combined cycle process 300 also includes a heat recovery steam generator (“HRSG”) 308, a corresponding steam turbine 309, and a corresponding generator 310. In addition, the gas turbine combined cycle process 300 includes an auxiliary air compressor 312 driven by a motor 314. It should be appreciated that an auxiliary air compressor having multiple stages or sections may be used, similar to the auxiliary air compressor shown in FIG. 1.

In operation, ambient air 316 is pulled into the compressor 302 and compressed. In addition, the auxiliary air compressor 312 driven by the motor 314 also takes ambient air 316 and generates an auxiliary stream of compressed air 318 that is fed to the compressor 302. The compressor 302 takes the ambient air 316 and the compressed air stream 318 from the auxiliary compressor 312 and further compresses the combined air stream to produce a compressed air stream 320 that is fed to the combustion section 303. Fuel 322 is also fed to the combustion section 303. The fuel 322 and the compressed air 320 are combusted to generate a high temperature, high pressure gas stream 324 that is fed to the turbine 304. The turbine 304 is caused to rotate, which concurrently rotates the shaft 305 associated with the generator 306, which in turn produces electricity. An exhaust gas stream 326 is discharged from the turbine 304. The exhaust gas stream 326 from the turbine 304 is fed to the HRSG 308, which recovers heat from the exhaust gas stream 326 to generate a steam stream 328. The steam stream 328 is fed to the steam turbine 309, which in turn drives the generator 310 to produce additional electricity.

It should be appreciated that the use and operation of the auxiliary air compressor 312 to produce the auxiliary stream of compressed air 318 is the same as that described in connection with the auxiliary air compressor 112 of FIG. 1. Accordingly, all of the details regarding operation and use of the auxiliary air compressor 112 of FIG. 1 are applicable to the auxiliary air compressor 312 of FIG. 3. Accordingly, it should be appreciated that the present invention, including the injection of compressed air into one or more locations along the compressor of the gas turbine can be applied to a combined cycle process as well. In some embodiments, the compressor air injection not only increases the gas turbine output, but it also increases the turbine exhaust energy, which increases the steam turbine generator output as well. Moreover, the additional description regarding the injection of the compressed air from the auxiliary compressor into the compressor in FIG. 2 is equally applicable to the combine cycle process 300 shown in FIG. 3.

Various embodiments of the invention have been described above. However, it should be appreciated that alternative embodiments are possible and that the invention is not limited to the specific embodiments described above. For example, the present invention can be used in conjunction with any large frame gas turbine.

What is claimed is:

1. A method for increasing the capacity of a gas turbine, comprising:
providing a gas turbine comprising a compressor section having a first compressor, a combustion chamber, and a turbine;
compressing air using a second compressor to produce compressed air from the second compressor;
feeding the compressed air from the second compressor into the first compressor at a location between the inlet and outlet of the first compressor to produce a combined compressed air stream exiting from the outlet of the first compressor;
passing the compressed air exiting from the first compressor to the combustion chamber;
feeding a fuel to the combustion chamber;
combusting the compressed air and the fuel in the combustion chamber to produce a gas stream; and
passing the gas stream through a turbine to rotate the turbine.

2. The method of claim 1, wherein said feeding the compressed air from the second compressor into the first compressor comprises:
feeding the compressed air from the second compressor into the first compressor through a pre-existing bleed port or extraction port.

3. A method for increasing the capacity of a gas turbine, comprising:
providing a gas turbine comprising a compressor section having a first compressor, a combustion chamber, and a turbine;
compressing air using a second compressor to produce compressed air from the second compressor;
feeding the compressed air from the second compressor into the first compressor at a location between the inlet and outlet of the first compressor to produce a combined compressed air stream exiting from the outlet of the first compressor;
passing the compressed air exiting from the first compressor to the combustion chamber;
feeding a fuel to the combustion chamber;
combusting the compressed air and the fuel in the combustion chamber to produce a gas stream;
passing the gas stream through a turbine to rotate the turbine and producing an exhaust gas stream from the turbine; and
passing the exhaust gas stream to a heat recovery steam generator.

4. The method of claim 2, wherein said feeding the compressed air from the second compressor into the first compressor comprises:
feeding the compressed air from the second compressor into the first compressor through a pre-existing bleed port or extraction port.
